(19) United States
(12) Patent Application Publication
(10) Pub. No.: US 2009/0283392 A1
(43) Pub. Date: Nov. 19, 2009

(54) LIGHT GUIDE KEY-PLATE AND LIGHT EMITTING KEYPAD COMPRISING THE SAME

(76) Inventor: Hyun Soo Kim, Gyeonggi-do (KR)

Correspondence Address: WILSON & HAM, 2530 BERRYESSA ROAD, PMB: 348, SAN JOSE, CA, 95132, US

(21) Appl. No.: 12/299,738

(22) PCT Filed: Aug. 30, 2007
(86) PCT No.: PCT/KR2007/004172

§ 371 Date: Nov. 5, 2008

(30) Foreign Application Priority Data
Nov. 2, 2006 (KR) 10-2006-0108030

(51) Int. Cl. H01H 9/00; H01H 13/76

(52) U.S. Cl. 200/314; 200/5 A

(57) ABSTRACT

A light guide key-plate and a light emitting keypad comprising the same including a light guide mechanism capable of surface-light emitting laterally incident light, and a plurality of keys formed on the light guide mechanism and capable of emitting light are provided, such that the light emitting keypad is remarkably slimmed over a light emitting keypad using a direct illumination method or a light guide plate using a separate light guide plate, thereby enabling to simplify the manufacturing and assembling processes.

### TECHNICAL FIELD

The aspects of the present inventive concept generally relate to light guide key-plates and light emitting keypads comprising the same.

### BACKGROUND ART

As typically known in the art, a light emitting keypad is applied to communication equipment such as a mobile phone and the light emitting keypad is used as a switch device for generating a signal or performing various supplementary functions. The light emitting keypad has the function of enabling identification of numeral or character keys at nights or in the dark. Recently, an ultra-thin light emitting keypad has been developed and employed as mobile phones become thinner.

FIG. 1 is a cross-sectional view of a conventional direct illumination type LED (Light Emitting Diode) keypad that comprises a PCB (Printed Circuit Board .100), domes (102), direct illuminating LEDs (103), and a keypad (104). The PCB (100) has contact terminals (101). Here, the plurality of domes and direct illuminating LEDs are installed on a front surface of the PCB. The keypad that has numerals or characters printed on an upper surface thereof and protrusions (105) formed on a lower surface thereof is installed in front of the domes and the direct illuminating LEDs.

In the direct illumination type LED keypad, the keypad is illuminated by light emitted from the direct illuminating LEDs installed on the front surface of the PCB. That is, when a user presses a key of the keypad, a protrusion corresponding to the key of the keypad allows a corresponding dome to be connected to a corresponding contact terminal of the PCB to generate a predetermined electrical signal. The generated electrical signal causes a corresponding LED to emit light so that the keypad can be directly illuminated by the LED in the form of a point light source.

However, the aforementioned direct illumination type LED keypad is manufactured to be relatively thicker since it is impossible to fabricate a thin keypad due to characteristics of the LEDs. Furthermore, the direct illumination type LED keypad may reduce a use time (life) of a battery since power consumption increases according to light emission of the LEDs. Furthermore, there is difficulty in designing the direct illumination type LED keypad since light emission uniformity may be irregular in accordance with the arrangement positions of the LEDs.

In order to solve the afore-mentioned problem, an indirect illumination method of inserting a keypad into a light guide plate, i.e., a light emitting keypad for emitting light by a light guide plate equipped with a side light source, has been proposed. However, the indirect illumination method has a shortcoming in that compactness suffers from insertion of a separate keypad into the light guide plate, and manufacturing/assembly of the separate light guide plate.

### DISCLOSURE OF INVENTION

### Technical Problem

The present disclosure is proposed to solve the aforementioned problem and therefore, an object is to provide a light guide key-plate and a light emitting keypad comprising the same, wherein a key-plate of a keypad is configured with a light guide mechanism capable of light guide function, dispensing with a separate light guide plate, to further realize slimness of the keypad, and to address problems involving costs and processes for manufacturing/assembling the separate light guide plate.

### Technical Solution

In one general aspect, a light guide key-plate comprises: a light guide mechanism capable of surface-light emitting laterally incident light; and a plurality of keys formed on the light guide mechanism and capable of emitting light.

Implementations of this aspect may include one or more of the following features.

The light guide mechanism is formed thereon with a colored layer except for a key region to thereby enable to express the key on a planar plate.

The light guide mechanism is formed with a slit for partially or wholly separating the key. The slit is filled with a transparent polymer material that has a higher ductility than that of the light guide mechanism or with silicone.

The light guide mechanism has a thickness in the range of 0.1 to 0.6 mm.

A reflective layer is formed between the colored layer and the light guide mechanism.

The light guide mechanism is formed at least one surface out of an upper surface or a bottom surface thereof with a pattern corresponding to an entire region or a partial region of the key.

The light guide mechanism is formed thereunder with a reflective layer for bringing contact thereinto or separating therefrom.

The reflective layer is a reflective sheet, and is formed by being attached to a tip end of, across, or an entire surface of the light guide mechanism using a two-sided tape. The light guide key-plate is further formed thereon with a hard coating layer.

In another general aspect, a light emitting keypad comprises: the light guide key-plate; and a substrate disposed with a dome switch mounted underneath the light guide key-plate.

Implementations of this aspect may include one or more of the following features.

The light emitting keypad further comprises a rear surface layer formed underneath the light guide key-plate with a bottom protrusion for applying pressure to the dome switch. The light emitting keypad is further disposed at an upper surface of the dome switch with a rear surface layer formed with an upper protrusion. The substrate is formed at a partial region or an entire region thereof with a reflective layer or a reflective sheet.

### Advantageous Effects

The present inventive concept can provide a light guide key-plate and a light emitting keypad wherein a key-plate perfumes a light guiding function, dispensing with a separate light guide plate, whereby a drastic slimness can be realized over the conventional light emitting keypad that uses a separate light guide plate to simplify the manufacturing and assembling processes.

### BRIEF DESCRIPTION OF THE DRAWINGS

FIG. 1 is a cross-sectional view illustrating a conventional direct illumination type LED light emitting keypad.

FIGS. 2, 3 and 4 respectively show a light guide key-plate in plan view, a cross-sectional view and a partially exploded view from exemplary implementations.

FIG. 5 shows a light guide key-plate in a cross-sectional view from another exemplary implementation.

FIGS. 6 and 7 show a pattern of a light guide key-plate in cross-sectional views from exemplary implementations.

FIGS. 8 and 9 show a reflective layer of a light guide key-plate in cross-sectional views from exemplary implementations.

FIGS. 10 to 13 show a light emitting keypad mounted with a light guide key-plate in cross-sectional views from exemplary implementations.

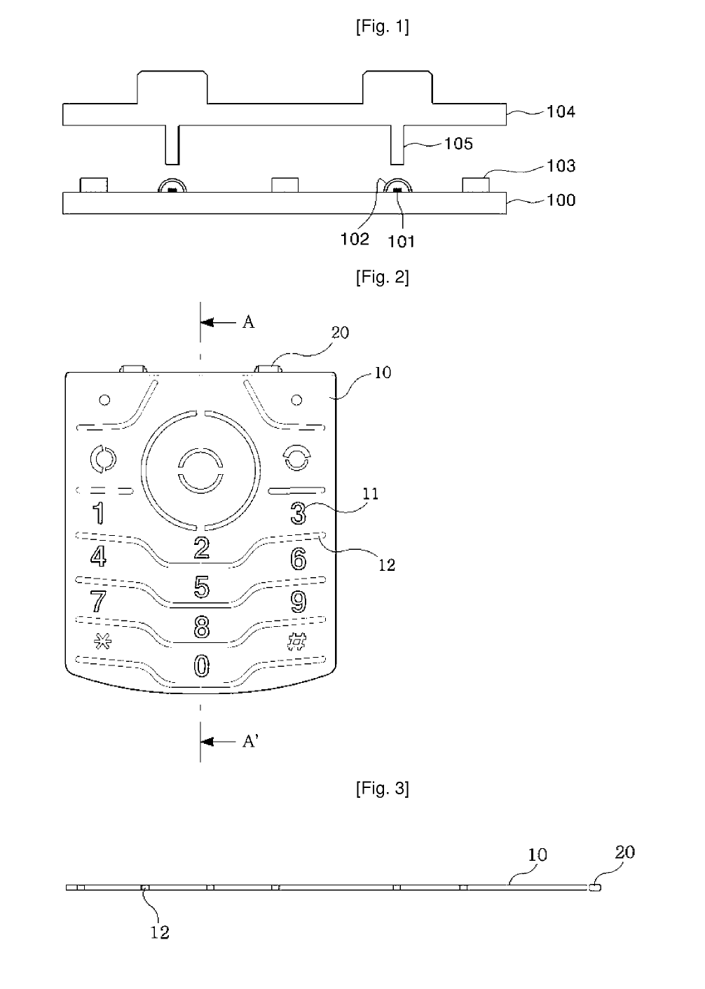

### BEST MODE FOR CARRYING OUT THE INVENTION

It should be noted that the following descriptions are nothing but the ones provided to assist in a comprehensive understanding of the general inventive concept. Thus, it should be apparent that the present disclosure and principle are provided to describe in the most useful and easiest way. No more detailed structures that are beyond necessity for understanding the basic principle are provided, and various changes and modifications of the instant novel concept will be exemplified for those of ordinary skill in the art to recognize. For example, although a portion described as ‘key’ in the scope of claims is given as a flat type in the following exemplary implementations, it is just a part of the exemplary implementations, and it should be apparent that a ‘key’ known in the art belonging to the present disclosure, for example, a protruding type of key, is also applicable to the ‘key’ of the instant teaching.

First of all, a light guide key plate will be described.

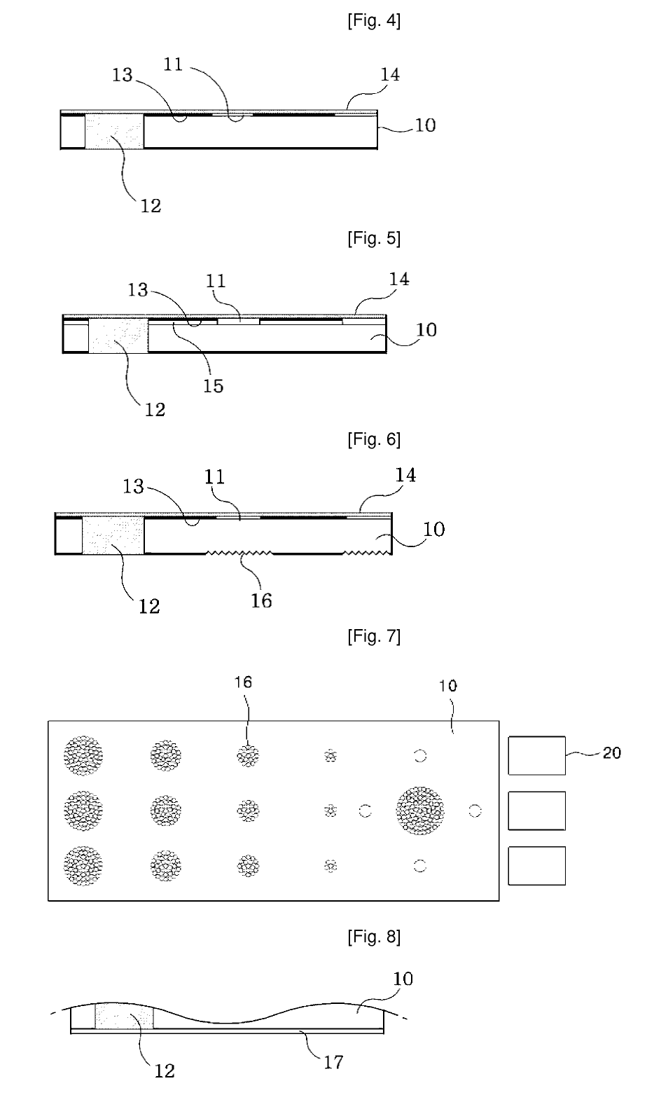

FIGS. 2, 3 and 4 respectively show a light guide key-plate in plan view, a cross-sectional view and a partially exploded view from exemplary implementations.

Referring to FIGS. 2, 3 and 4, the light guide key plate may include a light guide mechanism (10) capable of surface-emitting light incident from a lateral surface, and a plurality of keys (11) formed at the light guide mechanism (10) and capable of discharging light. The light guide mechanism (10) may be formed with a colored layer (13) at an upper surface thereof excluding a key (11) region to allow the key to be configured in flat type. Of course, the key (11) region may be colored in different colors, or formed in semi-transparency to distinguish the key (11) from other regions.

Any transparent materials having light guide property may be limitedly employed for the light guide mechanism (10) of the present implementations. The light guide mechanism (10) is preferably made of slim material having excellent light guiding and materialistic properties. Although not limited, for example, PC and PET may be good choices. The thickness of the light guide mechanism is preferably 0.1˜0.6 mm, and more preferably 0.2˜0.4 mm that is slim enough to provide a materialistic property required in a key plate. The light guide mechanism may be also expressed in a slimmed film style. Light emitted from a light source (20) at a lateral surface of the light guide mechanism (10) is incident, guided, changed to surface-emitting light, and irradiated to the front.

The key (11) may be formed in a flat plate as depicted in the drawings. In other words, the light guide mechanism may be expressed with a key in a color different from that of the other regions. In other words, as shown in the drawings, regions other than that of the key on the upper surface of the light guide mechanism may be provided with a colored layer to distinguish the key from the other regions. Furthermore, the key may be colored with a color different from that of the other regions. In doing so, the key and other regions may be discernable to allow the key to be expressed in a flat surface. Besides, methods of expressing the key may be variable, the methods of which belong to the scope of the present disclosure. The numeral or character keys may be desirably formed in transparency or semi-transparency to allow the light to be emitted in the shape of the key.

The colored layer (13) may be colored by way of printing or vapor-deposition to provide a stainless or magnesium feel, or may be etched in the shape of each key using etching method such as laser processing following formation of the colored layer to discern the key region from the colored region. The key plate in the instant implementation functions as a light guide, such that the colored layer must be disposed on the key plate to effectively exhibit the key. Furthermore, the colored layer may be made not to emit the light to thereby enhance the light contrast ratio of the key.

When the colored layer itself is made of material capable of reflecting relatively large amount of light, the light loss may be reduced to heighten the emission intensity of the key. In other words, reflective layer material (described later) may be used or a small amount thereof may be employed.

As illustrated, the light guide mechanism (10) is preferably formed with a slit (12) for separating part or an entire region of the key. If the slit (12) is formed at the light guide mechanism (10), a simultaneous depression of other keys may be avoided when a particular key (11) is pressed to prevent an erroneous operation from occurring and to enhance the click feel.

When the slit (12) is formed, a problem of light loss may arise at the slit region. In order to compensate the light loss, the slit may be filled with a transparent material having a higher ductility than that of the light guide mechanism to generate an effective light guide. By using material having a higher ductility than that of the light guide mechanism, the keys divided by the slit may independently move to enhance the light guide effect. The materials having a higher ductility than that of the light guide mechanism (10) may include, for example, rubber polyurethane or silicone.

Besides the configuration of filling the slit with the above-mentioned material, there may be other ways of employing the above-mentioned material, although not depicted in the drawings. For example, an upper surface and/or a bottom surface of the light guide mechanism is formed with a thin film made of unlimited material with a thickness of 10˜40 [symbol] and at the same time, the slit may be integrally filled with the material. When the slit is integrally filled as explained above, the material may be coupled to the slit more strongly than the material is filled only in the slit.

The light guide mechanism (10) is preferably formed thereon with a hard coating layer (14), by which problems including for example scratches may be solved. The slit portion may be exempt from formation of the hard coating layer to allow the slit to perform more effectively. The material for the hard coating layer is not particularly limited. For example, it is desirable to use thermoset resin having an excellent surface hardness by being cured with UV (ultraviolet) and/or heat. Examples of the material for the hard coating layer may be thermosetting silicone hard coating agent including silicone and melamine, UV-curable type hard coating agent including unsaturated polyester resin, radical polymerizable hard coating agent including acrylic, or cationic plymerizable hard coating agent including epoxy and vinyl ether. Furthermore, UV-curable resin that generates partial thermosetting by being added with some of the thermosetting composition may be also employed. The hard coating agent may be commercially obtained such that no further explanation thereto will be omitted.

### MODE FOR THE INVENTION

FIG. 5 shows a light guide key-plate in a cross-sectional view from another exemplary implementation, where the light guide key-plate is further comprised of a reflective layer (15) between the colored layer (13) and the light guide mechanism (10).

If a colored layer is not the light emitting region, there is a need of avoiding the generation of loss of light due to absorption by the colored layer. To this end, the light guide mechanism is first formed thereon with a reflective layer to thereafter form a colored layer, whereby the light is prevented from being absorbed by the colored layer through the reflective layer to enhance the light guidance efficiency.

FIGS. 6 and 7 show a pattern of a light guide key-plate in cross-sectional views from exemplary implementations.

Referring now to FIGS. 6 and 7, at least one of the upper or the bottom surface of the light guide mechanism (illustrative description of forming a pattern on the upper surface of the light guide mechanism is omitted) may be formed with a pattern (16) in a position corresponding to that of portion or an entire region of the key. Light emission may be more concentrated at a region with the pattern than at a region without the pattern because of refraction and scattering of light by the pattern.

It is preferable that patterns be concentratively formed at a particular region of the light guide mechanism to allow the light to be concentrated at the key region. (FIG. 7). Furthermore, it should be apparent that the size of the pattern be increased as the light source is distanced, and the size of the pattern be decreased as the light source is approached to thereby obtain a uniform light emitting surface. As it is important that the number and character key regions on the keypad be made to concentratively to emit light, it is desirable that the patterns be correspondingly positioned thereto. The shapes of the patterns may not be particularly limited. For example, the shapes of the patterns may be concave or convex.

The method of forming a pattern (16) is not particularly limited. For example, the method of forming the pattern (16) may include performing a hot press molding process, a printing process, an ultrasonic process, a laser process and an injection molding process. Preferably, the hot press molding process is employed for the forming of the pattern (16). The light guide film is considered to be a slim film, such that it is better to form the pattern by way of hot press molding process instead of hot press molding process. However, it should be noted that the injection molding process is not excluded. There may be a thermal deformation inflicted on the light guide film if too hot molds are used in the hot press molding process. Therefore, it is preferable to use molds that are heated to a temperature not to generate a loss to the light guide film. Although it is not limited, molds heated in the range of 70° C. to 150° C. are preferably used in the hot press molding process. Meanwhile, the patterns may be formed by silk printing of the light guide film with ink containing light scattering agent.

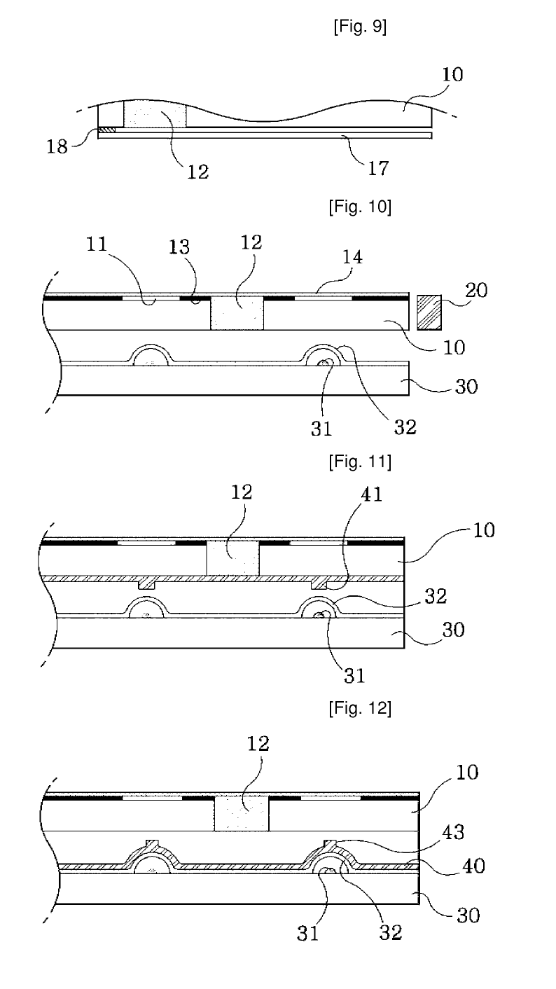

FIGS. 8 and 9 show a reflective layer of a light guide key-plate in partial cross-sectional views from exemplary implementations.

Referring to FIGS. 8 and 9, the light guide mechanism (10) may be formed thereunder with a reflective layer (17) that may be brought into contact with or detached from the light guide mechanism. The reflective layer is a reflective sheet, and may be formed by attaching one lateral end of a rear surface of, across, or a front surface of the light guide mechanism with an adhesive member, such as a double-sided tape.

A slim light guide mechanism may be inferior in light emitting efficiency to that of a thick light guide plate. To solve this problem, it is preferable that a reflective layer (17) for reflecting light that be lost be provided underneath the light guide mechanism.

There is no limitation of material on the reflective layer which may be selected from any of the existing material that can reflect light, but it is preferable to use white pigment alone or in a paste type. Preferably, the reflective layer may use one or more selected from a group consisting of Ag, TiO₂, ZnO, BaSO₄, ZnS, lead white and Sb₂O₃.

The reflective layer may be formed on a rear surface of the light guide mechanism using, for example, evaporation, coating or printing method. The evaporation, coating and printing method are well known such that no elaboration thereto will be provided herein.

Preferably, the reflective layer is a sheet containing reflective material, and may be formed by attaching one lateral end of a rear surface of, across, or an entire surface of the light guide mechanism with an adhesive member, such as a double-sided tape.

The reflective layer may be in complete contact with the light guide mechanism, or may be detached at a prescribed distance from the light guide mechanism. One of the methods of detaching the reflective layer from the light guide mechanism at a prescribed distance may include, for example, as depicted in FIG. 9, attachment to one lateral end, or both ends of the light guide mechanism using a double-sided tape (18) having a prescribed thickness. In other words, one lateral end or both ends of the light guide mechanism stacked to the reflective layer would generate a detachment of a prescribed distance as much as the thickness of the double-sided tape at a region except for that of the lateral end or both ends of the light guide mechanism.

If necessary, the length of the reflective layer may be made to be longer than that of the light guide mechanism, and a distal end of the reflective layer may be stacked to be further distanced as much as the extra length of the reflective layer. Particularly, in case of light emitting keypad, the light guide mechanism may be disposed thereunder with a substrate having a curved dome switch, it is preferable that the length of the reflective layer be long enough to allow the reflective layer to be tangent to the substrate disposed with the dome switch.

The distanced space between the reflective layer (17) and the light guide mechanism (10) would allow the light incident through the distanced space to be reflected by the reflected layer and discharged outside through the light guide mechanism, thereby enhancing the brightness of the light guide key plate.

Now, the light emitting keypad will be described in detail.

FIG. 10 shows a light emitting keypad mounted with a light guide key-plate in cross-sectional views from an exemplary implementation, wherein the light emitting keypad may include a substrate (30) disposed with the afore-mentioned light emitting key plate and dome switches (31, 32) mounted underneath the light guide key plate.

If necessary, other configurations may be added to the above construction. The light guide key plate has been fully described such that no more description will be provided herein.

There is no particular limit to the light source (20), but LED (Light Emitting Diode) is preferred for the light source. The LED may easily realize colors and is inexpensive in manufacturing cost. There is no particular limit to position of the light source but the light source may be positioned at a lateral end of the light guide key plate to become a lateral light source, and a lateral light emitted therefrom may be changed to a surface light by the light guide key plate.

The substrate (30) is not particularly limited, but it is preferable that the substrate (30) is a PCB (Printed Circuit Board) disposed with a dome switch comprised of a metal dome (32) and a contact terminal (31).

When a key of the key plate is depressed by a user, the depressed region is selectively and resiliently deformed to apply a pressure to a corresponding metal dome (32) of the PCB, whereby the metal dome (32) comes to contact the contact terminal (31) to be switched.

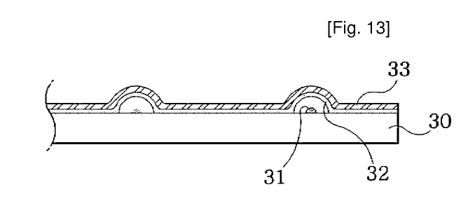

The metal dome may comprise any structure, such as one or more metal domes, as shown in FIG. 10, but may be an integral dome substrate as illustrated in FIG. 13.

FIG. 11 shows a light emitting keypad mounted with a light guide key-plate in cross-sectional views from another exemplary implementation. The light emitting key-plate may further include, as shown in the drawing, underneath the light guide key plate a rear surface layer formed with a bottom protrusion (41) for applying pressure to the dome switch.

The rear surface layer may include lots of bottom protrusions, or although not limited, may be integrally formed with the bottom protrusions. Preferably, the rear surface layer has an excellent resilient property and may be made of silicone or high polymer resin material.

The bottom protrusion (41) may comprise any structure, such as one or more bottom protrusions, but preferably many bottom protrusions to correspondingly be positioned to an entire or part of the keys of the light guide key plate. When a key of the key plate is depressed by a user, a bottom protrusion corresponding thereto is provided with a pressure to give rise to an electrical connection in a switching part of a dome switch.

FIG. 12 shows a light emitting keypad mounted with a light guide key-plate in cross-sectional views from still another exemplary implementation, where the keypad may further include a rear surface layer formed with an upper protrusion (43) on an upper surface of the dome switch. The rear surface layer and the protrusion have been already described such that no further description will be provided herein.

FIG. 13 shows a light emitting keypad mounted with a light guide key-plate in cross-sectional views from still another exemplary implementation, where a reflective layer (33) may be disposed on an entire upper region of the light emitting keypad or part of the upper region of the light emitting keypad. The reflective layer may include the aforementioned reflective sheet.

The disposition of the reflective layer on the substrate may reduce the light loss generated from the substrate to enhance the brightness of the light emitting keypad. In other words, part of the light incident on a distanced space between the reflective layer and the light guide key plate would may be reflected by the reflective layer to allow the light to be emitted outside through the light guide key plate discharged outside through the light guide key plate, thereby enhancing the brightness of the light guide key plate. Meanwhile, the dome switch may comprise any structure, such as one or more dome switches, but preferably an integral dome substrate, the structure of which may be applicable to the aforesaid implementations.

Exemplary implementations of the present disclosure have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present novel concept as set forth in the following claims.

### INDUSTRIAL APPLICABILITY

The present novel concept can provide a light guide key-plate and a light emitting keypad comprising the same capable of allowing the key plate to function as a light guide, dispensing with a separate light guide plate, by which a remarkably slimmed light guide keypad can be provided over a light guide keypad with a separate light guide plate.

1. A light guide key-plate comprising:
a light guide mechanism capable of surface-light emitting laterally incident light; and
a plurality of keys formed on the light guide mechanism and capable of emitting light,
wherein the light guide mechanism is formed thereon with a colored layer except for a key region to thereby enable to express the key on a planar plate.

2. A light guide key-plate comprises:
a light guide mechanism capable of surface-light emitting laterally incident light; and
a plurality of keys formed on the light guide mechanism and capable of emitting light,
wherein the light guide mechanism is formed with a slit for partially or wholly separating the key.

3. The key-plate as claimed in claim 2, wherein the slit is filled with a transparent polymer material that has a higher ductility than that of the light guide mechanism or with silicone.

4. A light guide key-plate comprising:
a light guide mechanism capable of surface-light emitting laterally incident light; and
a plurality of keys formed on the light guide mechanism and capable of emitting light,
wherein the light guide mechanism has a thickness in the range of 0.1 to 0.6 mm.

5. The key-plate as claimed in claim 1, wherein a reflective layer is formed between the colored layer and the light guide mechanism.

6. The key-plate as claimed in claim 1, wherein the light guide mechanism is formed at at least one surface out of an upper surface or a bottom surface thereof with a pattern corresponding to an entire region or a partial region of the key.

7. A light guide key-plate comprising:
a light guide mechanism capable of surface-light emitting laterally incident light; and
a plurality of keys formed on the light guide mechanism and capable of emitting light,
wherein the light guide mechanism is formed thereunder with a reflective layer for bringing contact thereinto or separating therefrom.

8. The key-plate as claimed in claim 1, wherein the reflective layer is a reflective sheet, and is formed by being stacked to a tip end of, across, or an entire surface of the light guide mechanism using a two-sided tape.

9. A light guide key-plate comprising:
a light guide mechanism capable of surface-light emitting laterally incident light; and
a plurality of keys formed on the light guide mechanism and capable of emitting light,
wherein the light guide key-plate is further formed thereon with a hard coating layer.

10. A light emitting keypad comprising:
the light guide key plate of claim 1; and
a substrate disposed with a dome switch mounted underneath the light guide key-plate.

11. The light emitting keypad as claimed in claim 10, further comprising a rear surface layer formed underneath the light guide key-plate with a bottom protrusion for applying pressure to the dome switch.

12. The light emitting keypad as claimed in claim 10, further comprising a rear surface layer disposed at an upper surface of the dome switch formed with an upper protrusion.

13. The light emitting keypad as claimed in claim 10, wherein the substrate is formed at a partial region or an entire region thereof with a reflective layer.

14. A light emitting keypad comprising:
the light guide key plate of claim 2; and
a substrate disposed with a dome switch mounted underneath the light guide key-plate.

15. A light emitting keypad comprising:
the light guide key plate of claim 4; and
a substrate disposed with a dome switch mounted underneath the light guide key-plate.

16. A light emitting keypad comprising:
the light guide key plate of claim 7; and
a substrate disposed with a dome switch mounted underneath the light guide key-plate.

17. A light emitting keypad comprising:
the light guide key plate of claim 9; and
a substrate disposed with a dome switch mounted underneath the light guide key-plate.
